(19) United States
(12) Patent Application Publication
(10) Pub. No.: US 2026/0272783 A1
(43) Pub. Date: Sep. 17, 2026

(54) TABLET SPLITTER

(71) Applicant: YUYAMA MFG. CO., LTD., Osaka (JP)

(72) Inventor: Naoki KOIKE, Toyonaka-shi (JP)

(73) Assignee: YUYAMA MFG. CO., LTD., Osaka (JP)

(21) Appl. No.: 19/079,251

(22) Filed: Mar. 13, 2025

(51) Int. Cl. A61J 7/00

(52) U.S. Cl. CPC A61J 7/0007

(57) ABSTRACT

A tablet splitter that splits tablets according to one or more embodiments may include: an upper body including an upper blade; a lower body including a lower blade; and a hinge that rotatably binds the upper body with the lower body. In one or more embodiments, the lower body may include a platform on which the tablets are placed; a slider that moves within the lower body in conjunction with the rotation of the upper body; and a lower blade holder that holds the lower blade and exposes the lower blade from the platform by raising the lower blade based on the movement of the slider. In one or more embodiments, the upper body is rotated with respect to the lower body to split the tablet by the upper blade and the lower blade.

### BACKGROUND

The disclosure relates to a tablet splitter for cutting tablets.

Tablet cutting shears and half-tablet cutters are known for dividing tablets, but these are cumbersome and time-consuming because they divide one tablet at a time.

As a device capable of splitting multiple tablets, U.S. Pat. No. 9,827,165 (Sundt) discloses a tablet splitter comprising a base member with a pair of alignment bars and a cover member with cutting blades. The tablet splitter is a plurality of pills or tablets placed on the upper end wall by unfolding a pair of alignment bars of the base member by hand, and after aligning the pills or tablets in a row by a pair of alignment bars, a plurality of pills or tablets are cut and divided by the cutting blade of the cover member by fitting and pushing the cover member into the base member.

In the tablet splitter disclosed by Sundt, multiple pills or tablets are cut at once by fitting and pushing the cover member into the base member. For this reason, a large amount of force may be required. In addition, since the cover member is separated from the base member, when the cover member is fitted to the base member and pushed in, the cutting blade of the cover member may be deviated from the center of the pill or tablet on the base member, and the pill or tablet may not be accurately divided into two. Furthermore, since a pair of alignment bars are forced in a direction approaching each other by a spring, when placing a tablet before dividing or taking out half a tablet after dividing, a pair of alignment bars must be pressed with a finger in the direction separated from each other.

### SUMMARY

A tablet splitter that divides tablets according to one or more embodiments may include: an upper body including an upper blade; a lower body including a lower blade; and a hinge for pivotably coupling the upper body to the lower body. In one or more embodiments, the lower body may include a platform on which the tablet is placed; a slider that moves in the lower body in conjunction with the rotation of the upper body; and a lower blade holder that holds the lower blade and exposes the lower blade from the platform by raising the lower blade based on the movement of the slider. In one or more embodiments, the upper body is rotated with respect to the lower body, and the tablet is divided by the upper blade and the lower blade.

A tablet splitter for dividing tablets according to one or more embodiments may include: an upper body including an upper blade; a lower body, including a lower blade; and a protrusion, and a hinge that joins the lower body to allow the upper body to be rotated. In one or more embodiments, the lower body may include a platform on which the tablet is placed; a fulcrum that rotates based on the rotation of the upper body and exposes the lower blade from the platform; a lower support provided in the vicinity of the hinge and in contact with the protrusion based on the rotation of the upper body; and a lower blade holder connected to the hinge and exposing the lower blade from the platform based on the rotation of the hinge. In or more embodiments, the upper body is rotated with respect to the lower body to divide the tablet from the upper and lower blades.

### BRIEF DESCRIPTION OF DRAWINGS

FIG. 1 is a diagram illustrating a perspective view of a tablet splitter according to one or more embodiments.

FIG. 2 is a diagram illustrating a perspective view of a tablet splitter according to one or more embodiments.

FIG. 3 is a diagram illustrating a 3-3 cross-sectional view of FIG. 2.

FIG. 4A is a schematic diagram illustrating a tablet splitter according to one or more embodiments.

FIG. 4B is a schematic diagram illustrating to explain an operation of a tablet splitter according to one or more embodiments.

FIG. 5A is a diagram illustrating a relationship between a lifter and a roller of a tablet splitter according to one or more embodiments.

FIGS. 5B and 5C are diagrams illustrating a lower blade holder and a lower blade according to one or more embodiments.

FIG. 6A is a diagram illustrating a perspective cross-sectional view of a lower body according to one or more embodiments.

FIG. 6B is a diagram illustrating a cross-sectional view of 6B-6B of FIG. 6A.

FIG. 7A is a diagram illustrating a perspective cross-sectional view of a lower body according to one or more embodiments.

FIG. 7B is a diagram illustrating a cross-sectional view of 7B-7B of FIG. 7A.

FIGS. 8A and 8B are diagrams illustrating a portion of a tablet splitter according to one or more embodiments.

FIGS. 9A, 9B, and 9C are diagrams illustrating cross-sectional views of an internal structure of a lower body 102 according to one or more embodiments.

FIG. 10 is a schematic diagram illustrating a tablet splitter according to one or more embodiments.

FIGS. 11, 12, and 13 are schematic diagrams illustrating an operation of a tablet splitter according to one or more embodiments.

FIG. 14 is a schematic diagram illustrating a tablet splitter according to one or more embodiments.

FIG. 15 is a diagram illustrating a cross-sectional view of a tablet splitter according to one or more embodiments.

FIG. 16 is a diagram illustrating a perspective view of a tablet splitter according to one or more embodiments.

FIG. 17 is a diagram illustrating a cross-sectional view of a tablet splitter according to one or more embodiments.

### DETAILED DESCRIPTION

The tablet splitter according to one or more embodiments is described in detail with reference to the drawings. In the description of the drawings, identical or similar parts may be denoted by the same or similar numerals. The description in the drawing is schematic, and the relationship between thickness and dimensions, the ratio of the length and thickness of each part, etc. are examples, and do not limit the scope of technical concept. Dimensional relationships and dimension ratios may vary between drawings. In the following description, when explaining the positional relationship of each component, “top”, “bottom”, “right side”, “left side”, etc. may be used appropriately based on the orientation of the drawing reference or a specific object, but these indications do not limit the scope of technical ideas. Expressions such as “top”, “bottom”, “right side”, “left side”, etc. may be used even when each part is not touched. “Longitudinal direction” may mean the direction of the long side on the main surface of the member. “Width direction” may mean the direction of the short side on the main surface of the member. “Height direction” or “vertical direction” may mean a direction related to the thickness of the main surface of the member. In addition, the X axis, the Y axis, the Z axis, or a combination thereof may be displayed in the figure, and “X axis direction”, “Y axis direction”, “Z axis direction”, “X axis direction”, “Y axis direction”, “Z axis direction” may be used in the specification or drawing to describe the direction.

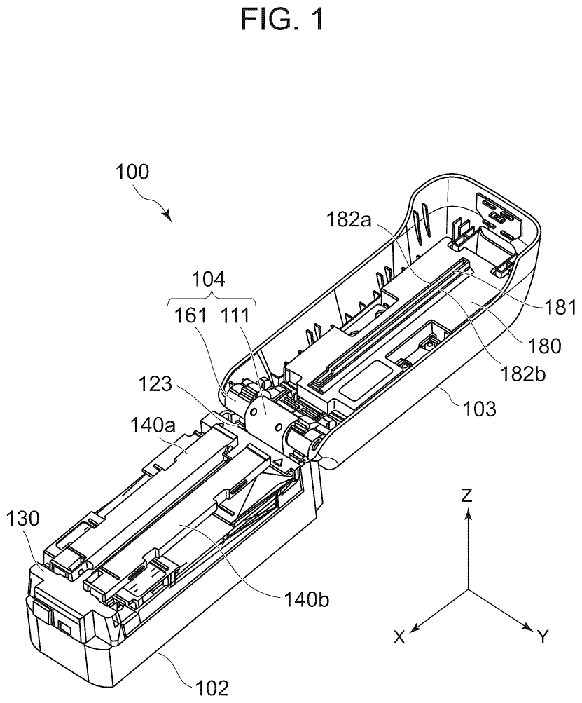

In particular, in the specification, for example, the lower body 102 opposite the hinge 104 of the tablet splitter 100 shown in FIG. 1 is referred to as “front”, the side on which the hinge 104 is provided is “back” of the lower body 102, the left hand side is “left” when viewed from the front to the rear of the lower body 102, and the right hand side is “right” when viewed from the front to the rear of the lower body 102. Further, with regard to the direction, the X direction shown in the figure may be referred as “forward”, the opposite direction of the X direction as “backward”, the Y direction as “right direction”, the opposite direction of the Y direction as “left direction”, the Z direction as “upward”, and the opposite direction of the Z direction as “downward”.

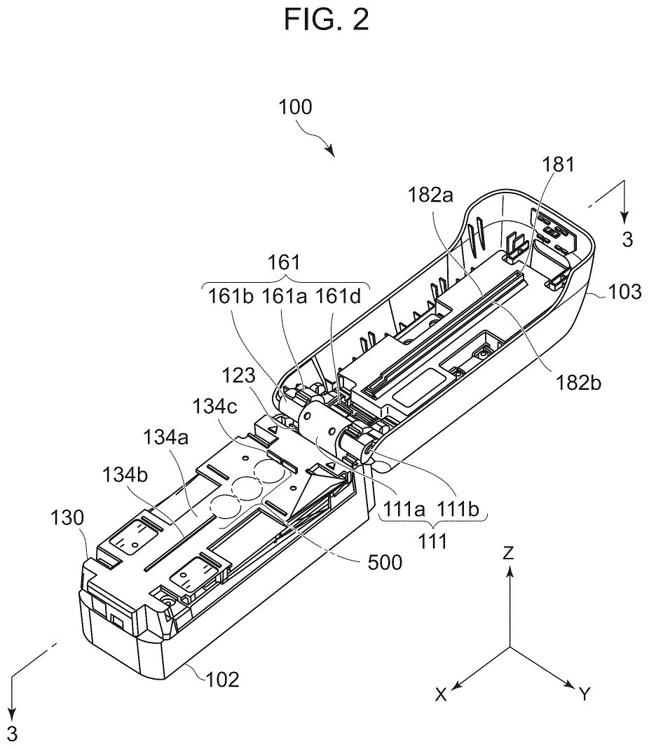

FIG. 1 is a diagram illustrating a perspective view of the tablet splitter 100 according to one or more embodiments. In the tablet splitter 100 shown in FIG. 1, the upper body 103 is opened from the lower body 102. FIG. 2 is a perspective view illustrating the tablet splitter 100 according to one or more embodiments. In FIG. 2, for convenience of explanation, the guide bars 140a and 140b shown in FIG. 1 are omitted.

When dividing the tablet, the tablet splitter 100 is closed so that the upper body 103 and the lower body 102 overlap by rotating the upper body 103 around the hinge 104 from the open state shown in FIGS. 1 and 2. The upper body 103 includes the upper blade 163, and the lower body 102 includes the lower blade 113. The tablet splitter 100 splits a plurality of tablets 500 into, for example, half tablets by the upper blades 163 and lower blades 113. The tablet splitter 100 includes the lower body 102 including a platform 130 on which at least one tablet is placed and the lower blade 113, an upper body 103 including the upper blade 163, and a hinge 104 that may be pivotably connects the upper body 103 to the lower body 102. For safety, when the tablet splitter 100 is opened, the lower blade 113 is stored inside the lower body 102. When the upper body 103 is closed, the lower blade 113 is exposed from the lower body 102. Similarly, for safety, the upper blade 163 is stored inside the upper body 103 when the upper body 103 is open. When the upper body 103 is closed, the upper blade 163 is exposed from the upper body 103. For example, a plurality of tablets arranged in a predetermined position are divided into two, for example, by the lower blade 113 and the upper blade 163 when the upper body 103 is closed.

The upper body 103 has a substantially rectangular shape that opens on the side facing the lower body 102 and covers the lower body 102 from above. The hinge 104 is placed at the rear of the upper body 103 and the rear of the lower body 103. The hinge 104 includes a lower hinge 111 connected to the rear of the lower body 102 and an upper hinge 161 connected to the upper body 103. The lower hinge 111 includes the hinge base 111a provided in the rear center portion of the lower body 102 and connected to the lower body 102, and the hinge shaft 111b provided at both left and right ends of the hinge base 111a and connected to the hinge base 111a. The upper hinge 161 includes the mounting portion 161d connected to the upper body 103, and two hinge bodies 161b that mate with the hinge shaft 111b. When the upper body 103 is closed to the lower body 102, a gear 161a that meshes with the gear 123 is placed in a part of the outer circumference of the hinge body 161B.

In the center of the inner surface of the top wall of the upper body 103, the upper movable member 180 is provided that is movable with respect to the upper body 103. The upper movable member 180 includes a slit 181 through which the upper blade penetrates, and ribs 182a and 182b arranged parallel to the slit 181 on the left and right sides of the slit 181. Ribs 182a and 182b are provided for safety. When the upper body 103 is closed, the upper movable member 180 is pressed against the lower body 102 to move in the direction of the top wall of the upper body 103. Thereby, the upper blade 163 is exposed from the slit 181 of the upper movable member 180.

The upper movable member 180 may be moved to a cutting position where the upper blade is exposed from the slit 181 and a retracted position where the upper blade is retracted from the slit 181 to the upper movable member 180. In this case, only the upper movable member 180 may move to expose or retract the upper blade, and the upper blade may not have to move up and down.

Next, the lower body 102 is described. The lower body 102 includes the platform 130 and a pair of guide bars 140a and 140b provided on the platform 130, as shown in FIG. 1. A pair of guide bars 140a and 140b are provided on the platform 130 and may be moved in the left and right directions (in the Y direction and in the opposite direction to the Y direction). The guide bars 140a and 140b may move at substantially equal intervals from the slit 134b.

For example, a mechanism may be used in which the guide bars 140a and 140b are linked and moved at substantially equal intervals from the slit 134b. For example, the guide bar 140a is connected to the first pinion, and the guide bar 140b is connected to the second pinion. The first pinion and the second pinion are connected to racks provided in the left and right directions (Y direction). The first pinion, the second pinion, and the rack have teeth, and the teeth of the first pinion and the teeth of the rack mesh, and the first pinion moves in the left and right directions as the rack rotates. Similarly, the teeth of the second pinion and the teeth of the rack mesh, and the second pinion moves in the left and right directions as the rack rotates. When the first pinion connected to the guide bar 140a and the second pinion connected to the guide bar 140b are connected to a common rack, the guide bars 140a and 140b may be moved at substantially equal intervals from the slit 134b in conjunction with each other. For the structure of the guide bars 140a and 140b, the first pinion, the second pinion, and the rack, the Japanese Patent Application Publication JP2023-84641 may be referred. Thus, since the guide bars 140a and 140b may be moved in the left and right directions, a plurality of tablets may be held regardless of the size and shape of the tablets. Further, by moving the guide bars 140a and 140b in conjunction with the slit 134b at substantially equal intervals, the substantial center of the tablet is placed on the slit 134b. This may allow the tablets to be accurately divided.

In FIG. 2, the platform 130 includes a tablet mounting slot 134a on which the tablet 500 is placed, a slit 134b through which the lower blade 113 penetrates, and a retainer plate 134c placed at the rear end of the slit 134b for regulating the position of the tablet 500 on the hinge 104 side to be placed. For convenience of explanation, the tablet 500 is illustrated, but it may not be included in the configuration of the tablet splitter 100 according to one or more embodiments. Further, in FIG. 2, a plurality of round tablets is shown as an example of the tablet 500, but are not limited thereto, an elliptical type, a square type, and the like may be used, for example. The tablet 500 is placed on the tablet mounting slot 134a. An interlocking mechanism (not shown) may be included to enable the guide bars 140a and 140b to move in the left and right directions in conjunction. By the interlocking mechanism, the substantial center of the tablet 500 is disposed on the slit 134b. The retainer plate 134c regulates the position on the hinge 104 side of the tablet 500 placed on the tablet mounting slot 134a. That is, the tablet 500 is regulated in the left and right directions by the guide bars 140a and 140b, and the rear direction is regulated by the retainer plate 134c. Note that the retainer plate 134c may not be provided on the slit 134b so as not to interfere with the lower blade 113 or the upper blade 163. In this case, the first retainer plate 134c may be placed on the right side of the slit 134b, and the second retainer plate 134c may be placed on the left side of the slit 134b.

The lower body 102 has a rectangular shape in which the longitudinal dimensions in the longitudinal direction are longer than the left-right dimensions when viewed from above. A lower hinge 111 is provided at the rear of the lower body 102. The lower hinge 111 includes a hinge base 111a and a hinge shaft 111b that is fixed to the hinge base 111a and extends in the left and right directions. A lower blade holder 112 is provided in the center of the upper surface of the lower body 102, and a lower blade 113 extending in the front-back direction is attached to the lower blade holder 112. The platform 130 may be fixed to the lower body 102.

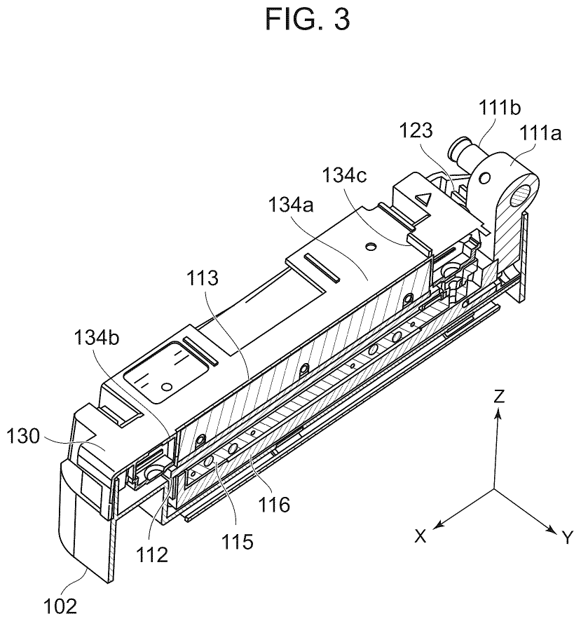

FIG. 3 is a perspective cross-sectional view illustrating the tablet splitter 100 according to one or more embodiments. FIG. 3 shows a 3-3 perspective cross-sectional view shown in FIG. 2. As shown in FIG. 3, the lower blade 113 divides the tablet 500 placed on the tablet mounting slot 134a of the platform 130 from below. The lower blade 113 is held in the lower blade holder 112. The slider 115 may move in the base member 116 in the forward and back (in the X direction and in the opposite direction to the X direction) in conjunction with the rotation of the upper body 102. The slider 115 is connected to the gear 123 and moves in the forward and back directions based on the operation of the gear 123. The slider 115 moves the lower blade holder 112 in the vertical direction by moving back and forth in the base member 116. When the lower blade holder 112 moves in the upward direction (Z direction), the lower blade 113 is exposed from the platform 130. The base member 116 regulates the movement range of the slider 115. Specifically, the base member 116 regulates the movement range of the slider 115 in the front-back direction. As the lower blade holder 112 moves in the vertical direction, the lower blade 113 also moves in the vertical direction. The lower blade 113 is exposed from the slit 134b when moving upward, and the tablet 500 placed on the slit 134b is divided with the upper blade 163 of the upper body 103.

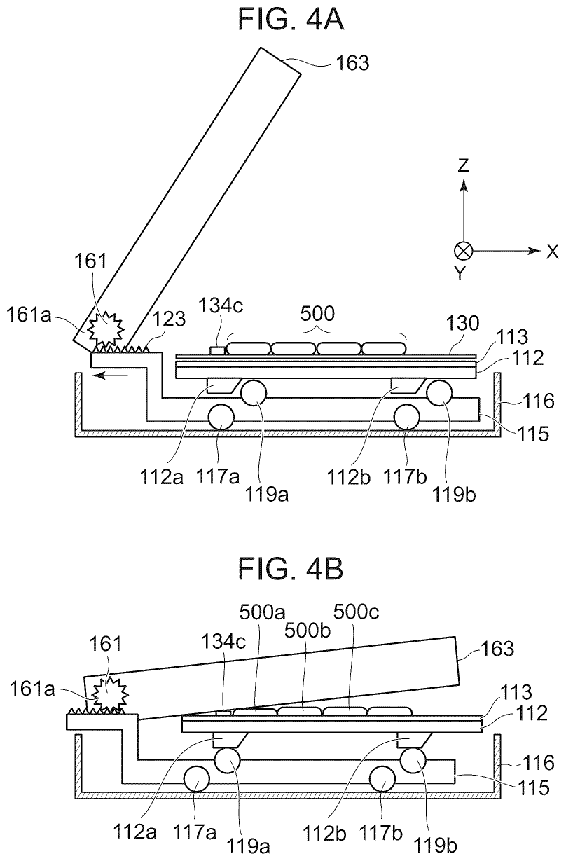

FIG. 4A is a schematic diagram illustrating the tablet splitter according to one or more embodiments. For the convenience of explanation, some parts are omitted from the illustration. FIG. 4A shows that the upper blade 163 is open. The upper blade 163 is stored in the upper body 103, but the upper body 103 is omitted in FIGS. 4A and 4B. The upper body 103 is connected to the upper hinge 161 and performs a rotation operation around the upper hinge 161. The upper hinge 161 includes gear 161a, which is meshed with the gear 123 connected to the slider 115.

The slider 115 includes bottom rollers 117a and 117b, and the bottom rollers 117a and 117b may allow the slider 115 to move in back and forth. The slider 115 may be moved in the forward and backward directions by rotating the bottom rollers 117a and 117b in contact with the inside of the base member 116. The placement of the bottom rollers 117a and 117b may allow for smooth and accurate movement of the slider 115 when the slider 115 is moved. The bottom rollers 117a and 117b may be provided on the bottom or side of the slider 115. Without limiting to this, for example, a side surface or a bottom surface inside the base member 116 may be in contact with the slider 115 to realize smooth movement. Any structure may be used as long as the slider 115 may slide back and forth without being limited to providing bottom rollers 117a and 117b. The slider 115 includes upper rollers 119a and 119b for moving the lower blade 113 up and down. The bottom rollers 117a and 117b may be embedded in the slider 115. Further, the bottom rollers 117a and 117b are provided in the front-to-back direction, but are not limited thereto, and may be provided with one, three, four, five, or more rollers.

The lower blade 113 is held in the lower blade holder 112. The lower blade holder 112 includes lifters 112a and 112b. The lifters 112a and 112b are placed on the bottom surface of the lower blade holder 112 and may be of a shape protruding from the bottom surface of the lower blade holder 112. With reference to FIG. 4A, the positional relationship between the lifters 112a and 112b and the upper rollers 119a and 119b is described. In order to ensure that the lower blade 113 is lifted when the slider 115 moves backward (opposite to the X direction), the lifter 112a is placed backward with respect to the upper roller 119a. Similarly, the lifter 112b is positioned backward with respect to the upper roller 119b. As a result, when the slider 115 moves backward, the upper rollers 119a and 119b also move backward. When the lifters 112a and 112b lift the upper rollers 119a and 119b, the lower blade holder 112 rises. Accordingly, the lower blade 113 is exposed from the slit 134b and the tablet is cut from below. As a result, the tablet is cut with the upper blade 163 and the lower blade 113 and divided into half a tablet.

With respect to the shape of the lifters 112a and 112b, as shown in FIG. 4A, the front surface may include a slope having a predetermined angle so that the lifters 112a and 112b may easily be ridden up when the slider 115 is moved. The lifters 112a and 112b are placed by extending in the left and right directions of the bottom surface of the lower blade holder 112. The lifters 112a and 112b may be provided across the left and right directions of the bottom surface of the lower blade holder 112. Further, the lifters 112a and 112b may be placed only in the portion where the upper rollers 119a and 119b are in contact. Further, the two lifters 112a and 112b are provided in the front-back direction, but are not limited thereto, and may be provided with one, three, four, five, or more lifters. Further, the upper rollers 119a and 119b are placed on the upper surface of the slider 115, but a part of the upper rollers 119a and 119b may be embedded in the upper surface of the slider 115. Further, the two upper rollers 119a and 119b are provided in the front-back direction, but are not limited thereto, and may be provided with one, three, four, five, or more upper rollers.

FIG. 4B is a diagram illustrating the operation of a tablet splitter according to one or more embodiments. For the convenience of explanation, some parts are omitted from the illustration. FIG. 4B shows that the upper blade 163 is in the process of closing. FIGS. 4A and 4B are used to explain the operation of the tablet splitter.

First, in a state where the upper body 103 is open to the lower body 102, that is, the upper blade 163 is open as shown in FIG. 4A, a pair of guide bars 140a and 140b are spaced. For this purpose, the interlocking mechanism described above (not shown) may be used. By using an interlocking mechanism, either one of the pair of guide bars 140a or 140b is moved in a direction away from the other. Alternatively, the other member moves away from one member through an interlocking mechanism. Next, a plurality of tablets 500 are placed on the platform 130 with a pair of guide bars 140a and 140b spaced apart. Note that when the pair of guide bars 140a and 140b are already separated and the tablet 500 are ready to be placed on a flat form, it is not necessary to operate on the pair of guide bars 140a and 140b.

After the tablet 500 is placed on the flat form, the guide bars 140a and 140b are moved in the direction in which the guide bars 140a and 140b are approaching. Here, a case of dividing the tablet 500 without a split line is described. The first tablet is placed so as to touch the retainer plate 134c on the tablet mounting slot 134a, and the second and subsequent tablets 500 are placed along the slit 134b in a direction away from the retainer plate 134c. At this time, the plurality of tablets 500 need not be precisely aligned. When the plurality of tablets are loaded, one of the pairs of guide bars 140a and 140b is moved in a direction approaching the other. Thereby, the other guide bar moves in the direction approaching one guide bar via an interlocking mechanism, and the plurality of tablets 500 are sandwiched between the guide bars 140a and 140b and aligned in a row. In this way, the multiple tablets 500 are aligned on the slit 134 by making the spacing between the guide bars 140a and 140b approximately equal to the width of the tablet 500. Thereby, the substantial center of the plurality of tablets 500 is disposed on the slit 134b.

Next, in order to cut the plurality of tablets 500 on the tablet mounting slot 134a, the upper body 103 is further rotated around the hinge 104 with respect to the lower body 102. Thereby, the upper body 103 is closed and brought closer to the lower body 102. Accordingly, the upper blade 163 performs a rotational operation around the upper hinge 161. At this time, the ribs 182a and 182b located on both sides of the slit 181 of the upper movable member 180 are in contact with a plurality of tablets 500 placed on the platform 130 of the lower body 102, and the reaction force moves upper movable member 180 toward upper body 103. Thereby, the upper blade 163 of the upper body 103 penetrates the slit 181 of the upper movable member 180 and is exposed from the upper movable member 180, and the tablet 500 is cut from above.

On the other hand, when the upper body 103 is rotated around the hinge 104 with respect to the lower body 102, the gear 161a linked to the upper blade 163 is also rotated. The gear 123 meshes with the gear 161a, causing the slider 115 to move backward. When the slider 115 moves backward, the upper rollers 119a and 119b provided in the lower blade holder 112 also move. When the upper rollers 119a and 119b move and touch the lifters 112a and 112b, the lifters 112a and 112b ride on the upper rollers 119a and 119b. Thereby, the lower blade holder 112 is lifted and moved upward, and the lower blade 113 penetrates the slit 181 and is exposed from the platform 130. When the upper body 103 is further closed, the lower blade 113 and the upper blade 163 are in contact with the tablet 500 on the platform 130, the lower blade 113 cuts the tablet 500 from below, and the upper blade 163 cuts the tablet 500 from above. Thereby, the tablet 500 is divided.

It may be preferable that the upper blade 163 and the lower blade 113 do not come into contact from the viewpoint of safety, such as preventing blade spillage. If the upper blade 163 and the lower blade 113 are close to each other to some extent without contact, the tablet may be divided. For example, the distance at which the upper blade 163 and the lower blade 113 are closest may be 1 mm or less, and may be 0.5 mm or less, particularly 0.4 mm or less, 0.3 mm or less, and 0.2 mm or less. Therefore, a mechanism may be provided to prevent the upper body 103 from lowering below a predetermined amount so that the upper blade 163 and the lower blade 113 do not come into contact. Further, a viewing window (not shown) may be provided on the upper body 103 for the upper blade 163, the lower blade 113, and the cutting status of the tablet. The viewing window may be provided with a transparent cover or may be open. Further, the entire upper body 103 may be made transparent.

Here, as shown in FIG. 4B, when the upper blade 163 and the lower blade 113 cut the tablet, the upper blade 163 and the lower blade 113 may be parallel or may draw a V-shape. When the upper blade 163 and the lower blade 113 draw a V-shape, the tablet 500a close to the hinge 104 is first cut, and then the tablet 500b close to the hinge 104 is cut. Thus, if the upper blade 163 and the lower blade 113 draw a V-shape, the plurality of tablets 500 are cut from the one closest to the hinge 104. Thereby, it may be possible to divide the tablets with a smaller force compared to the case of dividing a plurality of tablets 500 at the same time. Further, the upper blade 163 may be applied to the center position of the tablet 500 to accurately divide the tablet 500 into half tablets.

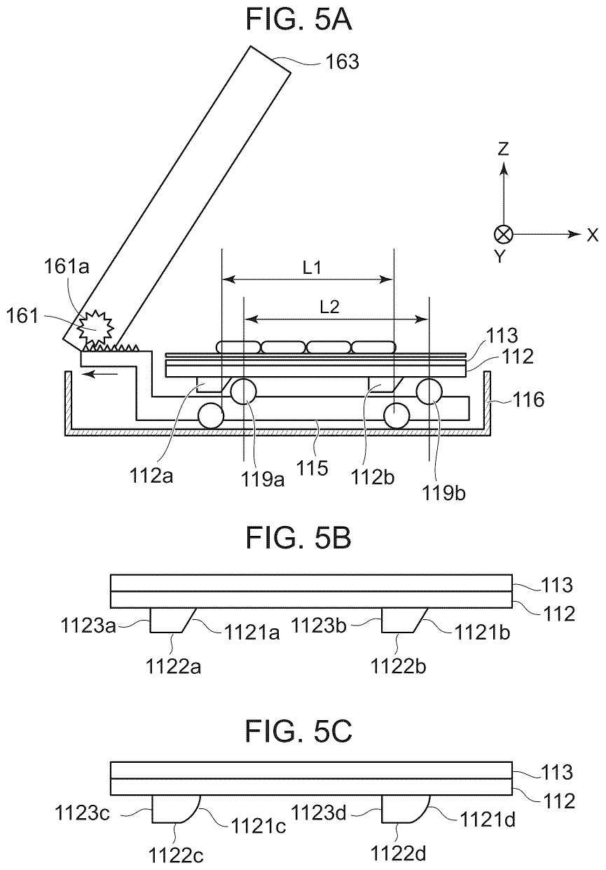

FIG. 5A is a diagram illustrating the relationship between the lifters 112a and 112b of the tablet splitter, and the upper rollers 119a and 119b according to one or more embodiments. As described above, when the lifters 112a and 112b ride up the upper rollers 119a and 119b, the lower blade 113 attached to the lower blade holder 112 rises. Here, the front-to-back distance between the lifters 112a and 112b is L1, and the front-to-back distance between the upper rollers 119a and 119b is L2. In this case, in the case of distance L1<distance L2, first, the lifter 112a rides up on the upper roller 119a first, and then the lifter 112b rides on the upper roller 119b. That is, in the case of a distance L1<distance L2, the lifter 112a rises first, and then the lifter 112b rises. In this case, the lower blade 113 touches in order from the tablet 500 close to the upper hinge 161. Thereby, a plurality of tablets 500 may be divided with a smaller force. In addition, since the lower blade 113 contacts the tablet 500 closest to the upper hinge 161, where the upper blade 163 contacts earlier, the advantage is that the timing of contacting each tablet with the upper blade 163 and the lower blade 113 may be matched to cut the tablets with the upper and lower blades 163 and 113.

FIG. 5B is a diagram illustrating the lower blade holder 112 and the lower blade 113 according to one or more embodiments. As shown in FIG. 5B, the lower blade holder 112 includes the lifter 112a and the lifter 112b. The lifter 112a includes the front surface 1121a that is first in contact with the upper roller, the bottom surface 1122a, and a rear surface 1123a. The lifter 112b includes a front surface 1121b, a bottom surface 1122b, and a rear surface 1123b. As shown, the front surfaces 1121a and 1121b have a slope from the lower blade holder 112 from the front to the rear. In other words, the front surfaces 1121a and 1121b have an obtuse angle to the bottom surfaces 1122a and 1122b. Further, there is a ridge line at the portion where the front surface 1121a and the bottom surface 1122a are connected. By including a slope in the front surface 1121a and 1121b, the lifters 112a and 112b gradually ride on the upper rollers 119a and 119b. Thereby, the lower blade 113 may gradually rise, and the lower blade 113 may be smoothly raised. The bottom surface 1122a and the bottom surface 1122b are substantially parallel to the upper surface of the slider 115. As a result, when the lifters 112a and 112b ride on the upper rollers 119a and 119b, the lower blade holder 112 may be stabilized on the upper rollers 119a and 119b. Here, the bottom surface 1122a and the bottom surface 1122b may not be the same length. For example, when the bottom surface 1122a is longer than the bottom surface 1122b, the rear of the lower blade holder 112 (in the opposite direction to the X direction) may be raised first, and then the front of the lower blade holder 112 may be raised.

FIG. 5C is a diagram illustrating the lower blade holder 112 and the lower blade 113 according to one or more embodiments. As shown in FIG. 5C, the lower blade holder 112 includes the lifter 112c and the lifter 112d. The lifter 112c includes the front surface 1121c, the bottom surface 1122c, and the rear surface 1123c. The lifter 112d includes the front surface 1121d, the bottom surface 1122d, and the rear surface 1123d. As shown, here, in FIG. 5B, there is a ridge line at the connection portion of the front surface 1121a and the bottom surface 1122a, but in the lower blade holder 112 shown in FIG. 5C, the connection portion of the front surface 1121c and the bottom surface 1122c is rounded. Thereby, a smooth rise of the lower blade 113 may be realized. The bottom surface 1122a and the bottom surface 1122b are substantially parallel to the upper surface of the slider 115. As a result, when the lifters 112a and 112b ride on the upper rollers 119a and 119b, the lower blade holder 112 may be stabilized on the upper rollers 119a and 119b. In the lower blade holder 112 shown in FIG. 5C, the front surfaces 1121c and 1121d are substantially vertical to the bottom surfaces 1122c and 1122d, but the front surfaces 1121c and 1121d may be inclined as shown in FIG. 5B.

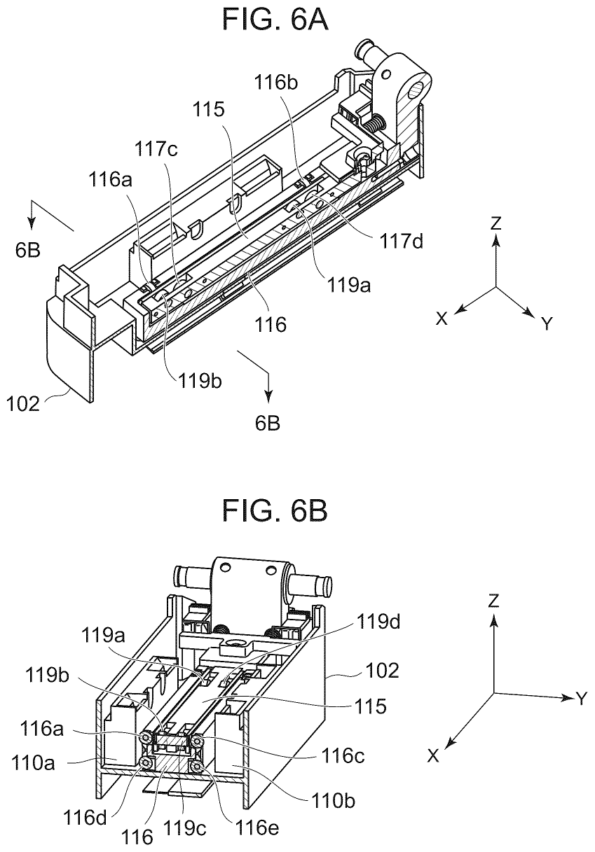

FIG. 6A is a perspective cross-sectional view showing the lower body 102 according to one or more embodiments. FIG. 6B shows a cross-sectional view of 6B-6B of FIG. 6A. FIG. 6A shows only the left side of the lower body 102 in the cross-sectional view, but FIG. 6B shows a cross-sectional view of the entire lower body 102. In FIGS. 6A and 6B, in particular, the base member 116 and the slider 115 in the lower body 102 are described, and other parts are omitted. The base member 116 is connected to the bottom surface of the lower body 102. The base member 116 includes rollers 116a and 116b on the side wall of the base member 116. The slider 115 is provided inside the base member 116 and may move back and forth (X direction). The slider 115 includes bottom rollers 117c, 117d, and upper rollers 119a, 119b. The slider 115 has two roller housing, and the bottom roller 117c and the upper roller 119b are stored in the first roller housing. Further, the upper roller 119a and the bottom roller 117d are stored in the second roller housing. The upper rollers 119b and 119a are arranged so that a portion thereof is exposed from the upper surface of the slider 115. Further, the bottom rollers 117c and 117d are arranged so that a part thereof is exposed from the bottom surface of the slider 115. The bottom rollers 117c and 117d are in contact with the bottom surface of the base member 116. The slider 115 moves back and forth while the bottom rollers 117c and 117d rotate.

In FIG. 6B, the base member 116 includes the bottom and the side surface, including rollers 116a, 116c, 116d, and 116e on the side. The slider 115 includes upper rollers 119a, 119b, 119c, and 119d on the upper surface. The guides 110a and 110b are arranged on the inner side wall of the lower body 102.

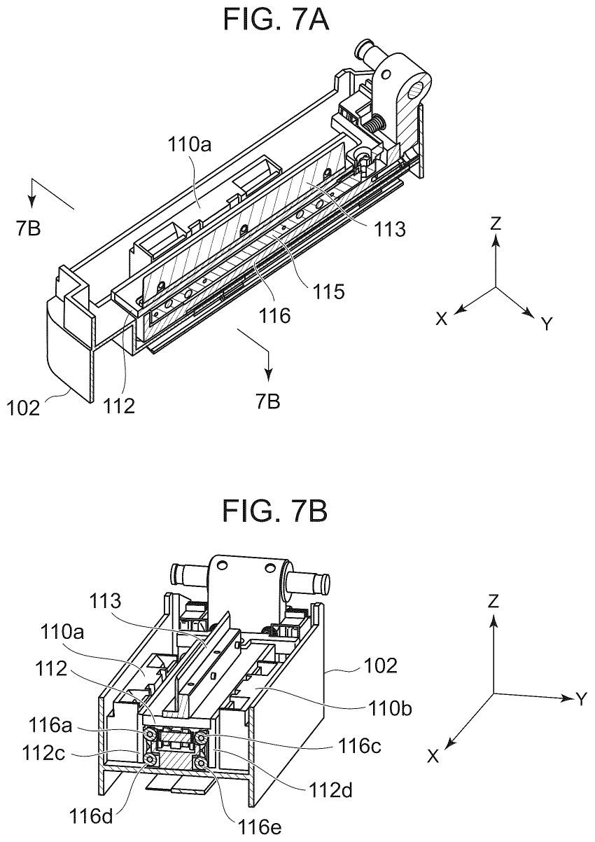

FIG. 7A is a perspective cross-sectional view showing the lower body 102 according to one or more embodiments. FIG. 7B shows a cross-sectional view of 7B-7B of FIG. 7A. FIG. 7A shows only the left side of the cross-sectional lower body 102, but FIG. 7B shows a cross-sectional view of the entire lower body 102. In FIGS. 7A and 7B, the lower blade holder 112 and the lower blade 113 in the lower body 102 are particularly described. The lower blade holder 112 is freely movable up and down on the upper surface of the slider 115. In FIG. 7B, the lower blade holder 112 includes a guide plate 112c provided and freely movable in the vertical direction between the guide 110a and the base member 116, and a guide plate 112d provided and freely movable in the vertical direction between the guide 110b and the base member 116. Base members 116 include rollers 116a, 116c, 116d, and 116e. As the lower blade holder 112 rises, the guide plates 112c and 112d also rise. When the guide plate 112c moves up and down, the rollers 116a and 116d provided on the side of the base member 116 rotate while in contact. Further, when the guide plate 112d moves up and down, the rollers 116c and 116e provided on the side of the base member 116 rotate while in contact. Since the lower blade 113 is required to accurately divide the tablet 500, it may be preferable that the deviation in the left and right directions is minimal. The lower blade holder 112 has guide plates 112c and 112d, and the guide plates 112c and 112d perform up-and-down movements while in contact with rollers 116a, 116c, rollers 116d, and 116e. The rollers 116d and 116e push the guide plates 112c and 112d from the inside to the outside of the guide plates 112c and 112d, so that the guide plates 112c and 112d do not move in the left and right directions (Y direction). As a result, smooth vertical movement may be realized while reducing friction between the guide plates 112c and 112d and the rollers 116a, 116c, rollers 116d, and 116e and the guides 110a and 110b when the lower blade holder 112 moves up and down. Further, it may be possible to reduce the deviation of the lower blade 113 in the left and right directions, which may allow for more accurate tablet splitting.

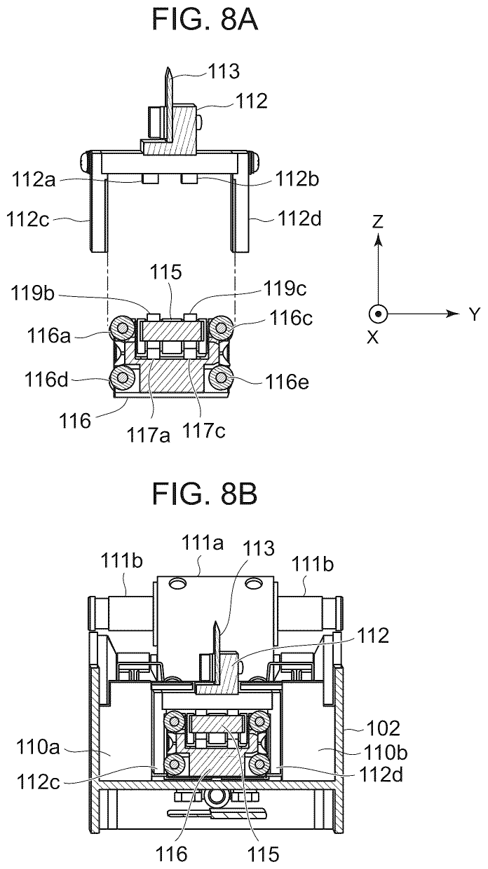

FIG. 8A is a diagram illustrating a portion of the tablet splitter according to one or more embodiments. In FIG. 8A, for convenience of explanation, the lower blade holder 112 to which the lower blade 113 is attached and the base member 116 to which the slider 115 is placed are shown separately. As shown, the lower blade 113 is fastened to the lower blade holder 112 with a bolt, a nut, or the like. The lifters 112a and 112b are placed on the bottom surface of the lower blade holder 112. The slider 115 may be moved in the back and forth (X direction) by the upper rollers 119a and 119c. The lifters 112a and 112b are placed in a position such that they ride on the upper rollers 119a and 119b when the slider 115 moves in the forward and rear directions. The guide plate 112c is provided so that it is in contact with the rollers 116a and 116b of the base member 116, and the guide plate 112d is provided so that it is in contact with the rollers 116c and 116e of the base member 116.

FIG. 8B is a diagram illustrating a portion of the tablet splitter according to one or more embodiments. In FIG. 8B, the lower blade holder 112 to which the lower blade 113 is attached, the slider 115, and the base member 116 are stored in the lower body 102. The guide plate 112c of the lower blade holder 112 is placed so as to be sandwiched between the guide 110a and the base member 116, and the guide plate 112d is placed so that it is sandwiched between the guide 110b and the base member 116.

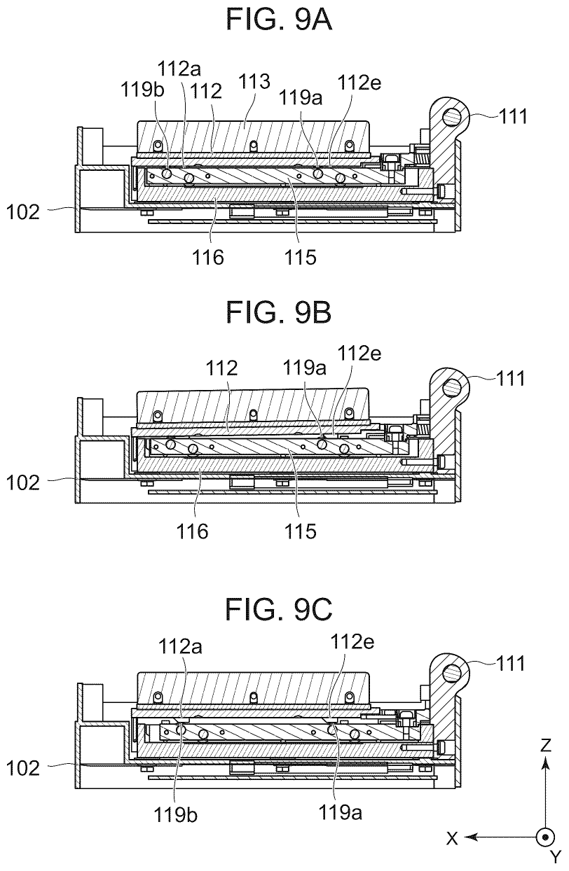

FIGS. 9A, 9B, and 9C are cross-sectional views showing the internal structure of the lower body 102 according to one or more embodiments. FIGS. 9A, 9B, and 9C are used to explain the operation of the tablet splitter according to one or more embodiments. In FIG. 9A, the tablet 500 is placed with the upper body 103 connected to the lower hinge 111 open. In this case, the bottom surface of the lower blade holder 112 to which the lower blade 113 is attached is in contact with the upper rollers 119a and 119b provided on the upper surface of the slider 115. The lifters 112a and 112b are stored in the first roller housing and the second roller housing provided in the slider 115. Thereby, the distance between the bottom surface of the lower blade holder 112 and the upper surface of the slider 115 may be narrowed, which makes it easier for the upper rollers 119a and 119b to contact the bottom surface of the lower blade holder 112.

In FIG. 9B, the slider 115 moves backward (in the opposite direction to the X direction) as the upper body 103 connected to the lower hinge 111 is closed. With the movement of the slider 115, the upper roller 119a also moves backward and is in contact with the lifter 112a. Further, as the upper roller 119a moves backward, the lifter 112a rides up to the upper roller 119a, and the rear side of the lower blade holder 112 rises. In FIG. 9C, when the upper body 103 connected to the lower hinge 111 is closed to a position that overlaps the lower body 102, the upper roller 119a moves further backward. As a result, the lifter 112b rides up on the upper roller 119b, and the front side of the lower blade holder 112 rises. Thus, first, the lower blade holder 112 close to the lower hinge 111 rises, and then the lower blade holder 112 that is far from the lower hinge 111 rises to the position where the upper part is closed, and the lower blade holder 112 is in a horizontal position. With such a configuration, when multiple tablets are placed, they are cut from the one closest to the hinge. Therefore, the tablets may be split with a small force compared to splitting a plurality of tablets all at once.

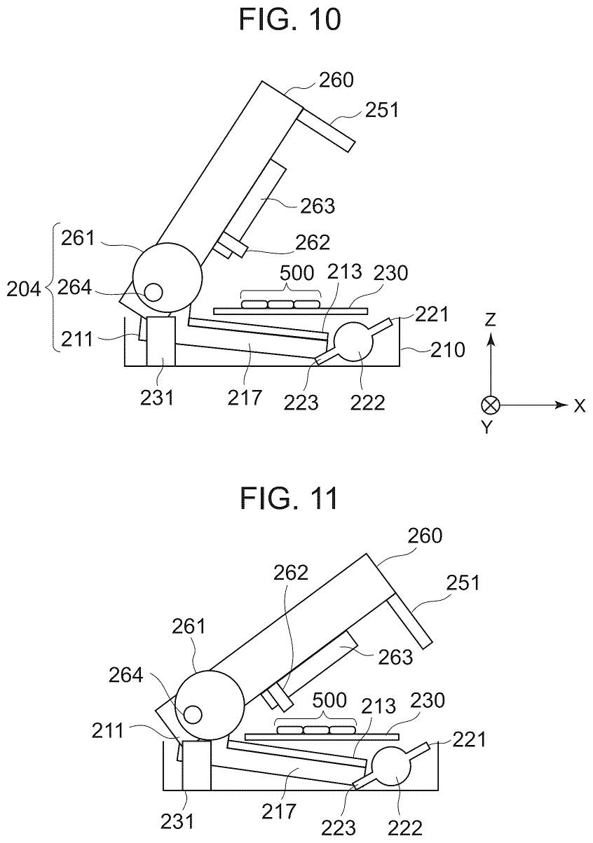

FIG. 10 is a schematic diagram illustrating a tablet splitter according to one or more embodiments. For the convenience of explanation, some parts are omitted from the illustration. The tablet splitter shown in FIG. 10 includes the upper body 260, the lower body 210, and the hinge 204 which connects the lower body 210 and the upper body 260. FIG. 10 shows an open state in which the upper body 260 is opened, and a tablet 500 is placed with the upper body 260 open. The upper body 260 includes the upper blade 263 and the support 251. The hinge 204 includes the upper hinge 261 connected to the upper blade holder 260, a center of rotation 264 of the upper hinge 261, and the hinge base 211. Further, the upper body 260 includes the protrusion 262. The upper body 260 is connected to the upper hinge 261. The lower body 210 includes the platform 230 on which the tablet 500 is placed, the fulcrum 222, the arm 221 connected to the fulcrum 222, the arm 223 connected to the fulcrum 222, the lower blade holder 217 that holds the lower blade 213, and the support 231 provided in the vicinity of the hinge 204. The arms 221 and 223 are connected to the fulcrum 222 and perform a rotational operation around the fulcrum 222. The support 231 and the fulcrum 222 are connected to the lower body 210.

FIG. 11 is a schematic diagram illustrating the operation of a tablet splitter according to one or more embodiments. For the convenience of explanation, some parts are omitted from the illustration. The tablet splitter shown in FIG. 11 is in a state where the tablet 500 is placed and the upper body 260 is closed. The upper blade 263 is connected to the upper hinge 261 and performs a rotational operation around the upper hinge 261. With the rotation of the upper hinge 261, the protrusion 262 also moves and approaches the platform 230. The rotation center 264 of the upper hinge 261 is provided offset from the center of the upper hinge 261. For this reason, when the upper body 260 is closed, the upper hinge 261 comes into contact with the support 231 as shown in FIG. 11, and the upper hinge 261 rides on the support 231. When the upper hinge 261 rides up on the support 231, the hinge 204 is held up by the support. Thereby, the tablet 500 may be contacted with the upper blade 263 and the lower blade 213 without tilting. If the upper blade 263 and the lower blade 213 are tilted, the position where the upper blade 263 and the lower blade 213 come into contact with the tablet is shifted from the center of the tablet, and the orientation of the dividing surface of the tablet may not be vertical. According to this configuration, since the upper body 260 is less likely to tilt, the tablet 500 may be more accurately divided into half a tablet. From the viewpoint of preventing the wobble of the hinge 204, the upper hinge 261 may come into contact with the support 231 from the stage of FIG. 10, but if the powder generated when dividing the tablet 500 enters the contact portion, the hinge 204 and the upper hinge 261 may interfere with mobility. In order to avoid a decrease in mobility of the hinge 204 and the upper hinge 261, as shown in FIG. 11, the upper blade 263 may be tipped down to some extent and then the upper hinge 261 may come into contact with the support 231. Further, the offset amount of the rotation center 264 may be an amount sufficient that the upper hinge 261 touches the support 231.

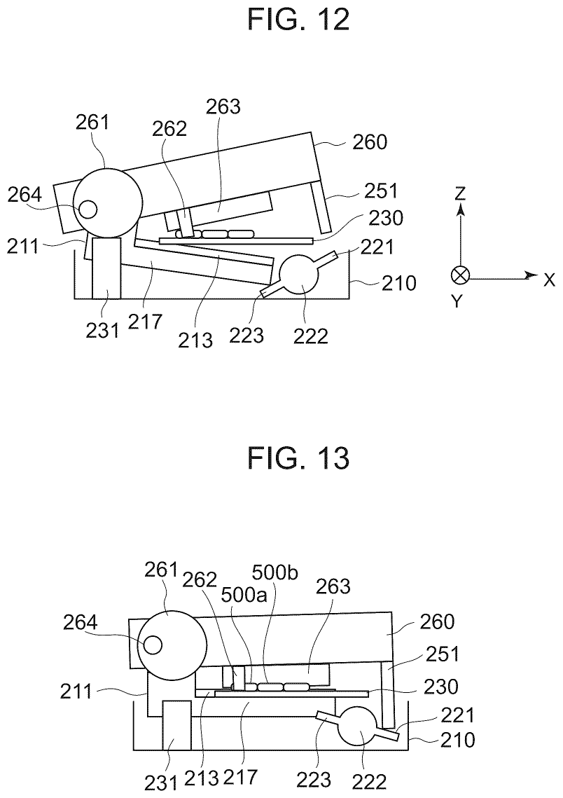

FIG. 12 is a schematic diagram illustrating a tablet splitter according to one or more embodiments. For the convenience of explanation, some parts are omitted from the illustration. In the tablet splitter shown in FIG. 12, the upper body 260 is further closed. When the upper body 260 is further closed, the protrusion 262 approaches the platform 230 and touches the platform 230. Further, the support 251 of the upper body 260 approaches the lower body 210, and the support 251 approaches the arm 221.

FIG. 13 is a schematic diagram illustrating a tablet splitter according to one or more embodiments. For the convenience of explanation, some parts are omitted from the illustration. In the tablet splitter shown in FIG. 13, the upper body 260 is closed. When the upper body 260 is pushed downward, the protrusion 262 comes into contact with the platform 230. When the upper body 260 is further closed, the upper body 260 is pushed downward to divide the tablet 500. Thereby, the upper body 260 rotates around the contact portion between the protrusion 262 and the platform 230. That is, the center of rotation of the upper blade 263 shifts from the center of rotation 264 to the contact portion between the protrusion 262 and the platform 230. When the upper body 260 rotates around the contact portion between the protrusion 262 and the platform 230, the hinge base 211 rises. As the hinge base 211 rises, a portion on the hinge base 211 side of the lower blade holder 217 rises, and at least a portion of the lower blade 213 on the hinge base 211 side is exposed from the platform.

When the tablet 500 is cut, the upper blade 263 and the lower blade 213 may be parallel, and may draw a V-shape. When the upper blade 263 and the lower blade 213 draw a V-shape, the tablet 500a close to the hinge 204 is first cut into, and then the tablet 500b near the hinge 204 is cut. Thus, if the upper blade 263 and the lower blade 213 draw a V-shape, the plurality of tablets 500 are cut from the one closer to the hinge 204. Thereby, it may be possible to divide the tablets with a smaller force compared to the case of splitting a plurality of tablets 500 all at the same time. Further, the upper blade 163 may be applied to the center position of the tablet 500 to accurately divide the tablet 500 into half tablets. To ensure the upper blade 263 and the lower blade 213 draw a V-shape when the cutting the tablet 500, the protrusion 262 first contacts the platform 230, and then the support 251 may be adjusted to push the arm 221 downward. This timing may be adjusted by considering the position and height of the protrusion 262, the length of the support 251, the arrangement of the fulcrum 222, and the like.

According to the tablet splitter according to one or more embodiments, the front of the lower blade holder 217 is raised by the fulcrum 222, and the rear part of the lower blade holder 217 is raised by the protrusion 262 in contact with the platform 230. In this way, the upper blade 263 and the lower blade 213 draw a V shape, so that the tablet may be accurately divided with a smaller force. Especially it has a great effect in the case of multiple tablets.

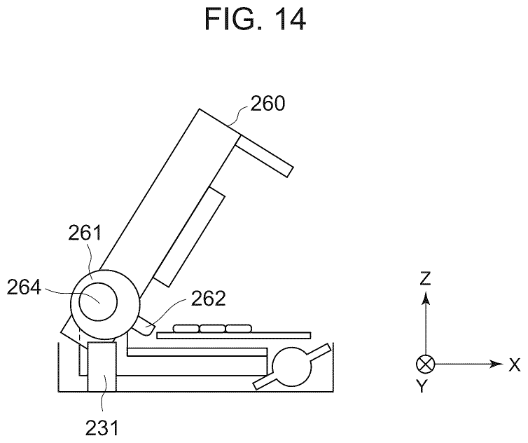

FIG. 14 is a schematic diagram illustrating a tablet splitter according to one or more embodiments. The tablet splitter includes a protrusion 262 provided on the upper hinge 261. When the upper body 260 is closed, the protrusion 262 provided in the upper hinge 261 approaches the support 231 and comes into contact with the support 231. Further, the support 251 of the upper body 260 approaches the lower body 210, and the support 251 approaches the arm 221. The upper body 260 is further closed, and the upper body 260 is pushed downward to divide the tablet 500. When the upper body 260 is pushed downward, the upper hinge 261 rotates further, and the protrusion 262 rides up on the support 231. As the protrusion 262 rides up on the support 231, the hinge base 211 connected to the lower hinge 264 rises. As the hinge base 211 rises, the rear side of the lower blade holder 217 also rises. Further, when the upper body 260 is pushed downward, the upper hinge 261 rotates further and the support 251 pushes the arm 221 downward. Since the arm 221 is connected to the arm 223 with the fulcrum 222 as the fulcrum, the arm 223 is pushed up when the arm 221 is pushed down. When the arm 223 is pushed up, the front side of the lower blade holder 217 is pushed up. Thereby, the lower blade 213 is exposed from the platform 230. Further, as described above, when the protrusion 262 rides up on the support 231, the rear of the lower blade holder 217 rises. Further, the front of the lower blade holder 217 rises when the arm 223 is pushed up. This may allow the tablets to be divided. Here, the center of the upper hinge 261 is offset from the center of the lower hinge 264. Thereby, the protrusion 262 is placed so as to be far from the center of the lower hinge 264. This arrangement increases the distance from the center of rotation, so that less force is required when pushing the upper blade holder 260.

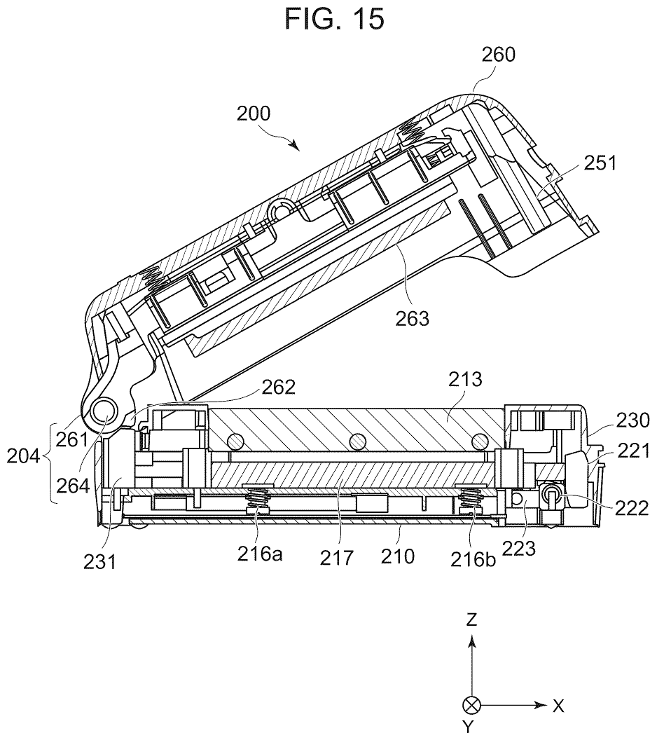

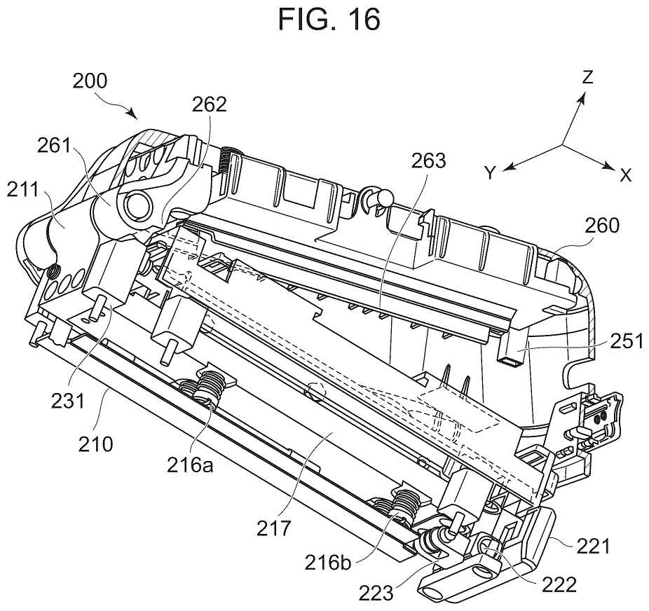

FIG. 15 is a cross-sectional view illustrating a tablet splitter according to one or more embodiments. The tablet splitter 200 includes the upper body 260, the lower body 210, the hinge 204 that connects the lower body 210 and the upper body 260. FIG. 15 shows an open state in which the upper body 260 is opened, and a tablet 500 is placed with the upper body 260 open. The upper body 260 includes an upper blade 263 and a support 251. The upper blade 263 and the support 251 may be fixed to the upper body 260. The hinge 204 includes an upper hinge 261 connected to the upper blade holder 260, a protrusion 262 provided in the upper hinge 261, and a lower hinge 264 connected to the lower body 210. The upper body 260 is connected to the upper hinge 261. The lower body 210 includes the fulcrum 222, the arm 221 connected to the fulcrum 222, the arm 223 connected to the fulcrum 222, the lower blade holder 217 that holds the lower blade 213, and the support 231 provided in the vicinity of the hinge 204. The arms 221 and 223 are connected to the fulcrum 222 and perform a rotational operation around the fulcrum 222. The support 231 and the fulcrum 222 are connected to the lower body 210. The lower blade holder 217 is connected to springs 216a and 216b. When the upper body 260 is closed, the lower blade 213 held in the lower blade holder 217 is exposed from the platform 230. Thereafter, for example, when the upper body 260 is opened to take the divided tablet, springs 216a and 216b force the upper body 260 downward (in the opposite direction in the Z direction). Thereby reducing the risk of the lower blade 213 remaining exposed for some reason when the upper body 260 is opened.

FIG. 16 is a perspective view illustrating a tablet splitter according to one or more embodiments. In FIG. 16, in order to show the internal structure of the tablet splitter, a part of the member may be cut out or omitted. As shown, the lower blade holder 217 is connected to the hinge base 211. As shown, when the upper body 260 is closed, the upper blade 263 performs a rotational operation around the upper hinge 261. The support 251 of the upper body 260 approaches the arm 221. Further, the protrusion 262 provided in the upper hinge 261 approaches the support 231 due to the action of closing the upper body 260.

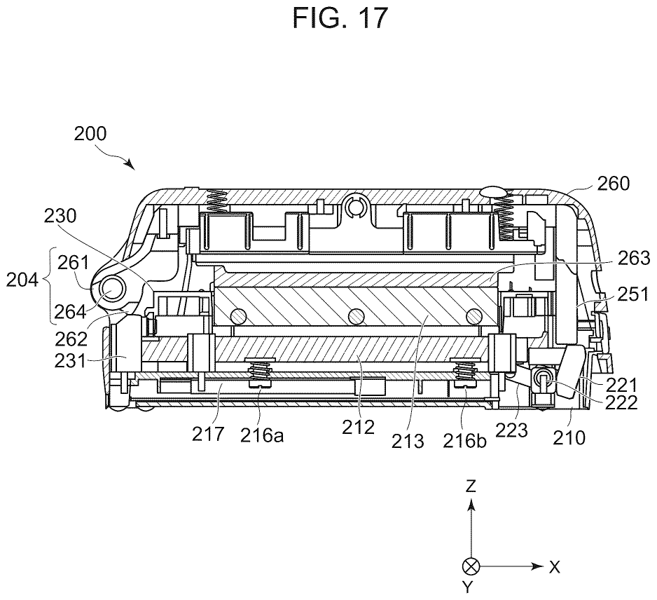

FIG. 17 is a cross-sectional view illustrating a tablet splitter according to one or more embodiments. The tablet splitter 200 shown in FIG. 17 has the upper body 260 closed. From the state of FIG. 17, the upper body 260 is further closed and overlaps the lower body 210. When the upper body 260 is pushed further downward, the upper hinge 261 rotates further, and the protrusion 262 rides up on the support 231. As the protrusion 262 rides up on the support 231, the hinge 204 rises in the Z direction, and the hinge base 211 connected to the lower hinge 264 rises in the Z direction. As the hinge base 211 rises, the rear side of the lower blade holder 217 also rises. Thereby, the lower blade 213 connected to the lower blade holder 217 is exposed from the platform 230.

Further, when the upper body 260 is pushed downward, the upper hinge 261 rotates further, and the support 251 pushes the arm 221 downward. Since the arm 221 is connected to the arm 223 with the fulcrum 222 as the fulcrum, the arm 223 is pushed up when the arm 221 is pushed down. When the arm 223 is pushed up, the front side of the lower blade holder 217 is pushed up. Thereby, the lower blade 213 is exposed from the platform 230. As described above, when the protrusion 262 rides up on the support 231, the rear of the lower blade holder 217 rises. Further, when the arm 223 is pushed up, the front of the lower blade holder 217 rises. Thereby, the tablet 500 may be divided.

Here, the timing at which the lower blade 213 is exposed from the platform 23 may be adjusted by adjusting the position of the protrusion 262 provided on the upper hinge 261 and the height of the protrusion. Further, by adjusting the length and position of the support 251, the arm 221 and 223, the timing at which the lower blade 213 is exposed from the platform 23 may be adjusted.

As described above, according to the tablet splitter according to one or more embodiments, a plurality of tablets may be accurately divided into half tablets with a small force.

The one or more embodiments described above may be combined with each other as long as they are practicable within the scope of the intended embodiment. The above-described embodiments are exemplary in all respects and should not be considered limiting. The illustrated and described embodiments may be extended to include other embodiments in addition to those specifically described, without departing from the technical scope. The technical scope should be determined not only by the foregoing description, but also in the light of the specification containing equivalents. Thus, all configurations, including the technical and equal ranges, are intended to be included in the technical range.

1. A tablet splitter that divides tablets comprising:
an upper body comprising an upper blade;
a lower body comprising a lower blade; and
a hinge that rotatably binds the upper body to the lower body, wherein
the lower body comprises:
a platform on which the tablet is placed;
a slider that moves in the lower body in conjunction with the rotation of the upper body; and
a lower blade holder that holds the lower blade, and exposes the lower blade from the platform by raising the lower blade based on the movement of the slider,
the upper body is rotated with respect to the lower body to split the tablet by the upper blade and the lower blade.

2. The tablet splitter according to claim 1, wherein
the lower blade holder comprises a lifter arranged on a bottom surface of the lower blade holder, the lower blade is exposed from the platform in conjunction with the rotation of the upper body by the lifter.

3. The tablet splitter according to claim 2, wherein
the slider comprises an upper roller arranged on the upper surface of the slider, and the lifter rides up the upper roller to expose the lower blade from the platform.

4. The tablet splitter according to claim 2, wherein
the lifter is arranged on a side of the hinge with respect to an upper roller when the upper body is opened from the lower body.

5. The tablet splitter according to claim 1, wherein
the lower blade holder comprises at least two lifters arranged on a bottom surface of the lower blade holder, and the slider comprises at least two upper rollers arranged on the upper surface of the slider.

6. The tablet splitter according to claim 5, wherein
a distance between at least two lifters arranged on a bottom surface of the lower blade holder is smaller than the distance between the at least two upper rollers arranged on the upper surface of the slider.

7. The tablet splitter according to claim 5, wherein
the lifter comprises a front surface that is in first contact with the upper roller, a bottom surface that is in contact with the upper roller when the lifter is in raised position, and a rear surface.

8. The tablet splitter according to claim 7, wherein the front surface forms an obtuse angle with respect to the bottom surface.

9. The tablet splitter according to claim 7, wherein the front surface has a curved surface.

10. The tablet splitter according to claim 3, wherein
the slider comprises a roller housing that houses the upper roller, and the upper roller is partially exposed from the upper surface of the slider.

11. The tablet splitter according to claim 3, wherein
the slider comprises a roller housing that houses the upper roller and the lifter, and the upper roller is partially exposed from the upper surface of the slider, and the lifter rides up on the upper roller to expose the lower blade from the platform.

12. The tablet splitter according to claim 1, further comprising
a base member that limits a range of the movement of the slider.

13. The tablet splitter according to claim 12, wherein
a bottom roller arranged at the bottom of the slider that moves in the base member.

14. A tablet splitter that divides tablets comprising:
an upper body comprising an upper blade and a protrusion;
a lower body comprising a lower blade; and
a hinge that rotatably binds the upper body to the lower body, wherein
the lower body comprises:
a platform on which the tablet is placed and is in contact with the protrusion based on the rotation of the upper body; and
a lower blade holder that is connected to the hinge and exposes the lower blade from the platform based on the rotation of the hinge; wherein
the upper body is rotated with respect to the lower body, and the tablet is divided by the upper blade and the lower blade.

15. The tablet splitter according to claim 14, further comprising
a fulcrum that rotates based on the rotation of the upper body and exposes the lower blade from the platform; wherein
the upper body comprises a support,
the fulcrum comprises:
a first arm that rotates the fulcrum upon contact with the support; and
a second arm that rotates based on the rotation of the first arm, wherein
the fulcrum exposes the lower blade from the platform based on the rotation of the second arm.

16. The tablet splitter according to claim 14, wherein
the lower blade is exposed from the platform by contacting the protrusion with the platform based on the rotation of the hinge.
